(19) United States
(12) Patent Application Publication
(10) Pub. No.: US 2004/0249895 A1
(43) Pub. Date: Dec. 9, 2004

(54) Method for rejecting SPAM email and for authenticating source addresses in email servers

(76) Inventor: Gregory G. Way, Bend, OR (US)

Correspondence Address: GLENN C. BROWN, PC, 777 NW WALL STREET, SUITE 308, BEND, OR, 97701, US

(21) Appl. No.: 10/806,788

(22) Filed: Mar. 22, 2004

Related U.S. Application Data
(60) Provisional application No. 60/456,382, filed on Mar. 21, 2003.

(51) Int. Cl. G06F 15/16

(52) U.S. Cl. 709/206

(57) ABSTRACT

This invention provides a method of blocking unwanted emails, yet provides the flexibility to permit the recipient to receive emails from new senders as desired. This invention provides a firewall with a list of approved senders as described above. In addition, however, the method of this invention permits the recipient to allow specific users to bypass the firewall.

### CROSS-REFERENCE TO RELATED APPLICATION

This application is a continuation-in-part of U.S. application Ser. No. 60/456,382, filed on Mar. 21, 2003. The priority of the prior application is expressly claimed and its disclosure is hereby incorporated by reference in its entirety.

### BACKGROUND OF THE INVENTION

Email has become an increasingly important and convenient method of personal and business communication. Email refers to the capability to send written communications over the internet to a specific recipient. Each email “user” is identified by a unique internet address, much like a street address. Email is implemented by any one of several specifications employed by all email providers. As used in this application, email refers to any electronic messaging system wherein an unauthorized sender could attempt to deliver a message without prior authorization from a user of the system.

The protocol for nearly all current email “systems” is defined by three Internet specifications known as “RFC” (request for comments) documents that ultimately were implemented as specifications: RFC 1939 for POP3, RFC821 for SMTP authored by Jonathan B. Postel, and the ESMTP extensions in RFC 1869. These documents are in the public domain and found primarily at www.isi.edu/in-notes, and are incorporated herein by reference in their entirety. An RDC search engine is available through www.rfc-editor.org.

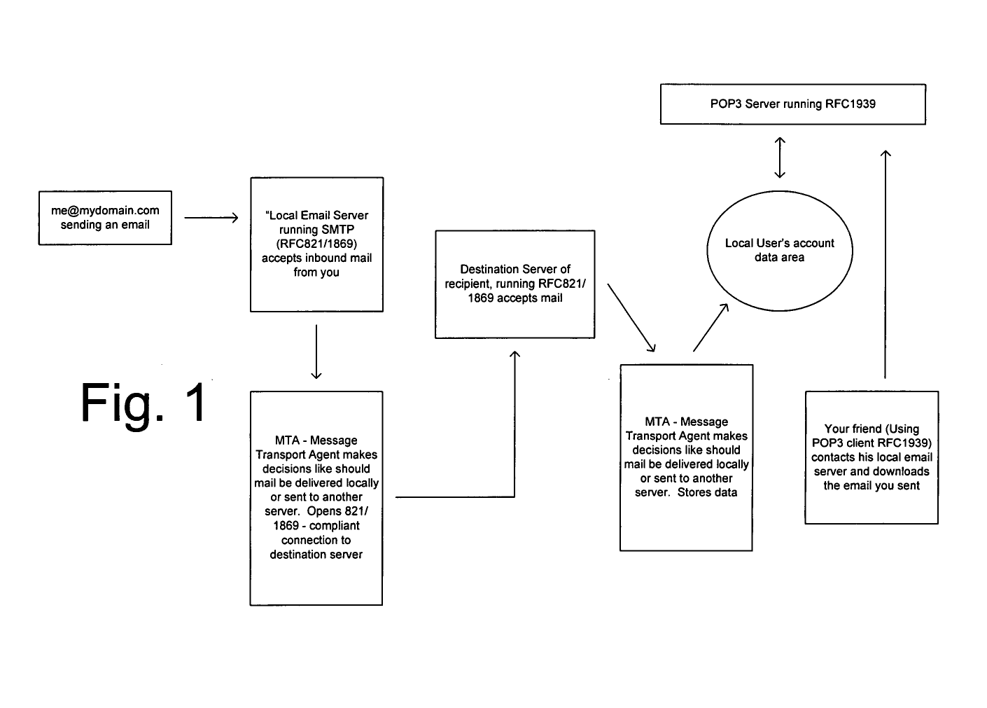

Specifications RFC821 and RFC1939 are the two primary protocols by which email servers are able to exchange mail via software running on desktop and laptop computers. RFC1939 defines the specification for our interaction with email servers in receiving email. RFC821 and 1869 define the specification for how email servers send mail to each other and get email from email users. For example, when a sender sends an email message, the email is sent first to the sender's email server, which is typically located at your email service provider's facility. RFC821/1869 defines this process. Once the sender's email server has received the message it uses software often referred to as a message transport agent (MTA) to decide how to route that email. Should it need to go to another email server, RFC821/1869 are used again to send that message to the destination email server. If you in fact had sent that message to yourself then it would be placed in a location where your software would login and receive it, using RFC1939. FIG. 1 is a simplified schematic block diagram of a typical email process as implemented today using the specifications referenced above. It should be noted that the email client or desktop software does not normally communicate with any other email servers other than the one it has been assigned. The process of moving mail around the Internet is actually left to email servers that may make many decisions based on each email they receive.

The great thing about email is that anyone can send a message to anyone, and it is typically delivered to the recipient's mail box in real-time for retrieval at the recipient's convenience. While this basic feature is in part what makes email so wonderful, it opens the door for abuse. One particularly irritating form of abuse comes in the form of the sending of unsolicited commercial email (“UCE”), also known as “SPAM”, in the Internet community. UCE, or SPAM, is an unsolicited email from a source from whom the recipient did not ask to receive email. The word “unsolicited” is the key point; the recipient did not ask nor approve the sender to send a message.

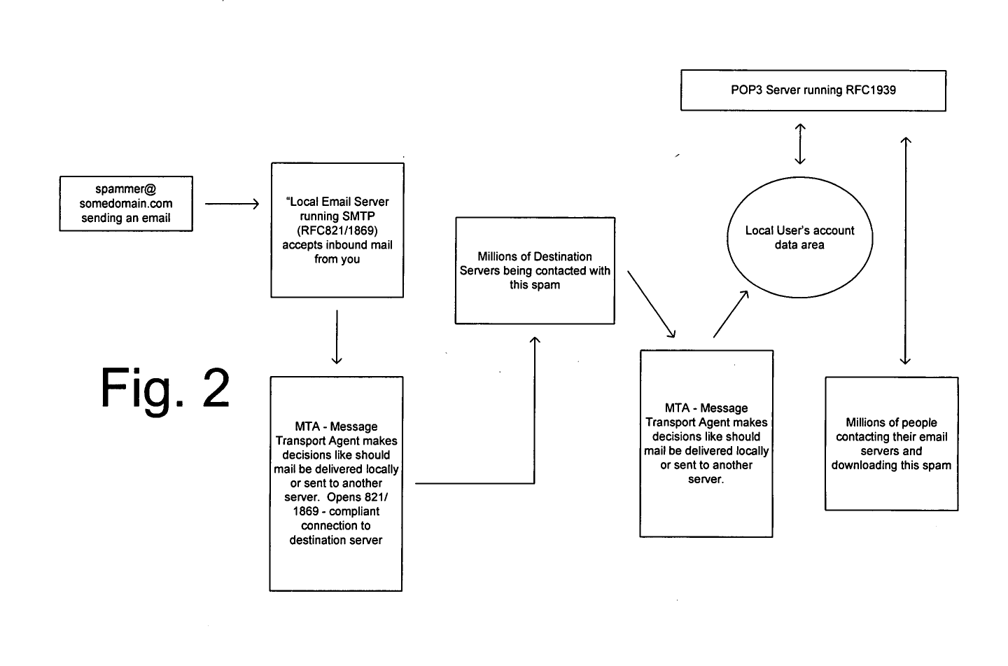

For the most part the reason we get Spam is because individuals and or companies look to profit from the seemingly low cost that email offers in reaching millions of Internet users. Spammers send email out to many people or companies to advertise the Spammer's products or services. Spammers obtain emails from vendors who buy email addresses from other merchants who have communicated with the recipient and have placed the recipient's email in a data base for their own purposes, and as a valuable piece of information that can be sold to Spammers. A typical process for sending Spam “or bulk email” to as many as a million or more recipients is shown in FIG. 2. Using the method shown in FIG. 2, the Spammer can take advantage of the ability of computers to automatically transfer a recipient's email address from a data base of email addresses to an email message (solicitation), and to then automatically send each of those emails to those many recipients, all very quickly and with very little operator intervention required.

In the early days of the Internet Spam was not a very big problem. Since then the Internet, and email in particular, has experienced explosive growth. As the use of email has grown, so has the problem of Spamming until today the problem has reached enormous proportions, costing business millions if not billions of dollars every year. While there is no reliable estimate of the volume of Spam flowing through the Internet today, nearly all email users receive unwanted email. Many people using Internet email spend anywhere from 5 minutes to an hour each day deleting SPAM. Also, it is not uncommon to inadvertently delete important business or personal email while in the process of manually deleting the unwanted SPAM. The following block diagram expanding on Diagram (1) shows a typical process that creates 1 Spam for millions of Internet users.

Unwanted email can also take other forms. A user can wish to receive no further emails from a sender. Young users can receive emails that are sent for the purpose of engaging the young user in an inappropriate dialogue. For all of these reasons there is a need for an effective method of screening Spam and unwanted emails.

One known method for blocking Spam is quite simple. In order to block unwanted email, the recipient's email server is instructed to accept email from an approved list of email senders, and to reject email from all other senders. Any email not on this list would be promptly rejected using the unauthorized codes provided for in RFC 821. Hence the email server would remain in compliance of Internet standards. REF: R: 550 Access Denied to You. In Internet terms this accept/reject approach is known as a “Firewall”, and is implemented by software that is widely available. The term “Firewall-List” will be used herein to refer to this list and the process. The following is a schematic block diagram showing a typical Email Firewall-List and its use in an RFC821 compliant server.

However, this simple solution creates a big problem. The problem is that in everyday life people want email from people that they may have just met, or from whom they do not have advance notice of the email. Under the blocking method above, a significant advantage and utility of email is lost. A need therefore remains for a Spam blocking method that effectively blocks unwanted email, while at the same time allows the email recipient to accept and receive emails from new senders as desired.

This invention provides a method of blocking unwanted emails, yet provides the flexibility to permit the recipient to receive emails from new senders as desired. This invention provides a firewall with a list of approved senders as described above. In addition, however, the method of this invention permits the recipient to allow specific. users to bypass the firewall.

### Method for Authenticating Source Addresses in Email Servers

The invention described above includes a step of authenticating email source addresses in as a step in blocking spam email messages. Electronic Mail or “Email” is the most widely used communications tool for business and personal communication on the Internet. At the technical level, Email often also refers to an open set of programming guidelines known as specifications which programmers base their logic upon when creating software to process email messages. An email server is a machine running software developed based on the Email specifications. The specifications are known as Request For Comments “RFC” documents. The founder of Email, Jonathan B. Postel, authored the early versions of the RFC documents that are in use today. Specifically, RFC 821 and RFC 1869 are what provide the guidelines for sending and receiving email on the Internet. RFC 1939 provides the guidelines for authorized downloading of email from an email server and is also the most widely implemented specification. It is because the programmers use specifications for building email servers that any email server can pass messages to any email server on the Internet. The University of Southern California Information Sciences Institute played a significant role in the originating of many RFC documents and they maintain a web site where these specifications may be found at www.isi.edu/in-notes. An RFC search engine is also provided at www.rfc-editor.org.

Email technology provides the freedom for its users to send and receive written communications over the Internet in near real-time. This freedom exists in part because users pay for Internet services and service providers provide them with access to the Internet. There is almost never a fee paid for each message sent or received via Email. This makes the apparent cost of this extremely convenient technology minimal. In recent years however, individuals and companies looking to profit from the low cost of sending email to millions of users on the Internet have abused this freedom. So many of these email-abusing users are sending so many emails that they are now driving up the costs of email dramatically and frustrating millions of email users by making them download and sort-through considerable volumes of messages that they did not want to receive. Today the problem is costing business dollar figures estimated in the billions not including the loss in productivity and is threatening the future viability of email as the rate of abuse continues to grow exponentially.

It is the mission of almost every Internet service provider to reduce the amount of Spam their customers receive and untold millions are currently being spent each year in research and development of new techniques. The source of this problem comes from the underlining fact that sending email messages is, for the most part, a process that does not require authentication. If Email messages were authorized as being from whom they claim to be from, a drastic reduction in Spam would occur and additional solutions could be put in place that would, in fact, eliminate Spam completely, or at the very least create such a barrier to abuse that it would no longer be profitable to engage in abuse practices and thus thwart the primary motive behind abuse.

This Invention provides a solution to authenticate Email messages as a foundation for Anti-Spam technologies. The technology, called “source-address-authentication” or “source authentication”, sets out a series of processes in which an email message is authenticated by virtue that the sender must have been authenticated by an email server to download email in order to reply to a confirmation email that they are in fact the authorized user of the email address specified in the ‘from’ address of the Email message. This Invention will work regardless of what techniques are used to authenticate the user. For instance, a “Web Mail” user may be sending and receiving messages through their web browser and authenticated via a web site while a “POP3 Mail” user may be sending and receiving messages through an Email client and authenticated through the POP3 specification. Both of these users are authenticated to access their email account and by replying to an email sent to that account, they confirm those rights to the destination email server. This allows the technology to source-authenticate a user without requiring advanced knowledge of what kind of email delivery system they are using.

The Invention works in conjunction with the SMTP specifications RFC812 and RFC1869, and through the implementation of a message transport agent or “MTA”. The MTA of an email server is the brains of the server in that it makes email routing decisions. When an email message comes to an email server, if it is successfully transmitted and stored it is then passed to MTA software for routing. The MTA decides whose email account it is for or if the email must be passed on for delivery to another email server or in some cases if both need to be done. The first part of the Invention sets up processes where the MTA software will temporarily store email messages that come from unauthorized sources. It will then build an email message directed to the sender of the email message asking that the sender of the email simply reply to the MTA originated email, on behalf of the named recipients. The email message also contains an ID code meaningful to the MTA software as to which email message this is for. It may or may not include an image of a word or a set of numbers embedded in the email message for the recipient to confirm that they can see by entering into a location specified by the reply email.

Critically important is that the MTA also include data that identifies itself to the email server that is now the recipient email server for the reply email that it is in fact authorized to send this “reply-email”. In addition, this data also notifies the recipient server that this message is a “reply-email” and must be sent to the recipient.

The invention provides for different means for this authentication to be passed to the email server of the alleged sender. The first method involves simply specifically formatted text and specific language in the reply email that identifies the message as being a reply and containing no other content. In this scenario the sending server is authenticated to send the email because the content itself is acceptable by virtue that it cannot be a Spam message. It may also include portions of the header of the original email it received to further authenticate the legitimacy of sending the reply email. In addition, the IP address of the machine sending the reply must be found in the reverse DNS lookup for the domain it claims to be from.

The second method involves passing a phrase in the email header that is comprised of information that is known only to the destination server that is only for the sending server. For example, the sending server might pass something that would look like “S-Auth: MSG04020639198.53X” in the email header. The email header may contain the phrase “SourceAuthentication: ID” where ID can be any string of characters. The inclusion of “Sourc eAuthentication:” in the header however tells the destination email server that if it is running Source Authentication it may replace the body of the email with specific authentication text so as to not allow SA messages themselves to become spam.

If the recipient server verifies that the embedded code is what is allocated for that server to accept replies from the sending server, then it will allow the reply email to be delivered. The failback mechanism, in case of any processing errors, would be as provided for in the first method.

Once the sender receives the email, should the sender reply to the email, that email is sent to the original recipient server. Should that email match the requirements of the MTA that originated the reply, the MTA will then release the original email sent by the sender for further processing in accordance with its design for delivery of an email message.

In another preferred embodiment, the email headers of the incoming message and the reply message are compared in order to determine whether the original email and the reply to the authentication request are from the same sender. In this embodiment the email headers of the original message and the reply to the authentication request are compared. Specifically, various fields of the respective email headers are examined to determine whether there a predetermined number of headers from the authentication request reply and the original email match. If so, the original email is deemed to not be spam and is delivered. If not, the original email is not delivered, and a message is delivered to the sender of the original email that their email is undeliverable. The method is illustrated by the following example.

An original email is received by the MTA server, which initially reviews the original email to determine whether the source address shown in the “MAIL FROM” field of an SMTP connection or the “return path” of the email header identifies a sender that has been included in the intended recipient's list of pre-approved senders. If so, the MTA delivers the email to the intended recipient. If not, the MTA generates and sends an authentication request to the sender listed in the “MAIL FROM” field. The authentication request includes an identification string of characters that the MTA then uses to track the authorization request and to evaluate any reply to the authentication request.

In response, a reply email would be returned to the sender that would include an arbitrary series of characters in the subject box, and would also include the arbitrary series of characters in the body of the email, e.g.:

Subject: Source Authentication Request ID:MSG04020639198.53X

SourceAuthentication:MSG04020639198.53X.txt

The body of the authentication request would also include a request for the sender to reply to the authentication request to verify that it is the sender of the original email.

If no reply is received from the authentication request within a predetermined period of time, the original email is deemed to be spam, and is not delivered. If the authorization request is returned as a bounce, the original email is also deemed to be spam and is not delivered.

In one preferred embodiment of the invention, if no reply to the authorization request is received, or if the authorization request is bounced, the original email is directed to a spam repository where spammers can be identified and tracked for enforcement purposes, or in order to create a list of known spammers. In another embodiment a list of known spammers is accumulated from the email headers of rejected emails and used a “block list”. All incoming emails are then initially screened to determine whether the sender's address is included on the block list, and if so, the email is rejected as undeliverable.

In one embodiment, the rejection message includes a message that the email has been rejected because the sender has been identified as a spammer, and invited to contact the ISP if the sender believes it has been wrongly identified as spammer. If a reply to the authentication request is received, its header is compared to that of the original email to determine if the source of the reply to the authentication request is the same as that of the original email message. Each subsequent email from the sender goes through the “Source Authentication” header comparison to verify that the sender is in fact who they say they are and not a spammer simply using a known email address of the recipient.

A typical email header included as part of an original incoming email is as follows:

Return-path: <janedoe@spam.com>
Received: from mx2. cable.com (mx2. cable.com [192.168.17.31]) by pop-server.
cable.com
(Rockliffe SMTPRA 4.5.6) with ESMTP id <B0138688136@pop-server.cable.com> for
<johndoe@cable.com>;
Fri, 6 Feb 2004 10:52:32 -0800
Received: from [204.140.220.99] (www.spam.com [204.140.220.99]) by mx2. cable.com
(Rockliffe SMTPRA 5.2.5) with ESMTP id <B0000610901 @mx2. cable.com> for
<johndoe@cable.com>;
Fri, 6 Feb 2004 10:52:31 -0800
Message-ID: <B0000610901 @mx2. cable.com>
Received: from spam.com ([204.140.220.8]) by spam.com (dedicated MTA v6.1) with
SMTP id BAS2003
From: <janedoe@spam.com>
To: johndoe@cable.com
Date: Fri,06 Feb 2004 10:53:18 -0700
Subject: Hello
Content-Type: text/html;

The email header of the reply received responsive to a request for authorization would typically appear as follows:

Return-path: <johndoe@spam.com>
Received: from mx2.cable.com (mx2.cable.com [192.168.17.31]) by pop-server.cable.com
(Rockliffe SMTPRA 4.5.6) with ESMTP id <B0138688136@pop-server.cable.com> for
<janedoe@cable.com>;
Fri, 6 Feb 2004 10:52:32 -0800
Received: from [204.140.220.99] (www.spam.com [204.140.220.99]) by mx2.cable.com
(Rockliffe SMTPRA 5.2.5) with ESMTP id <B0000610901 @mx2.cable.com> for
<johndoe@cable.com>;
Fri, 6 Feb 2004 10:52:31 -0800
Message-ID: <B0000610901 @mx2. cable.com>
Received: from spam.com ([204.140.220.8]) by spam.com (dedicated MTA v6.1) with
SMTP id BAS2003
From: <janedoe@spam.com>
To: johndoe@cable.com
Date: Fri,06 Feb 2004 10:53:18 -0700
Subject: Source Authentication Request ID:MSG04020639198.53X
SourceAuthentication:MSG04020639198.53X.txt
Content-Type: text/html;

The email headers of the original email and the reply to the authentication request are then compared by comparing particular fields of the headers of the respective emails. The fields that are compared in the preferred embodiment include return-path field, the reply-to field, the X-sender field, the FROM field, the X-mailer field, the message-ID field, and the connecting IP address field.

In one embodiment of the invention, if a predetermined number of fields of the respective email headers match, the original email is designated as “not spam”, and is delivered to the intended recipient. In one preferred embodiment if any four of the fields of the two email headers match, then the original email is delivered as “not spam.” The invention is not intended to be limited to any particular number of matching fields, and different users could even specify lesser or greater levels of matching. In other embodiments, different fields can be assigned different weighted values, and if the comparison of the email headers results in a total weighted match score, the email is delivered as “not spam.” For example, If the method is implemented on a server level then the connecting IP address might be given greater weight, and of particular interest would be whether the IP address is a user on the server's network, what is the domain name of the reverse-DNS look up value of the IP address, and whether the domain name from the reverse-DNS look up value of the IP address matches the sender's domain. In addition, the server might store the reverse DNS of the IP address for comparison at a later time.

In another aspect of the invention, the authorization request can be customized to the user's preferences, e.g. so as not to unduly trouble or offend potential clients or other first time email correspondents. In each case the authorization request includes a header depicting the email as an authorization request, and the system forces the text of the authorization request to become the default text. This assures that spammers cannot attempt to get through by mimicking the header of the authorization request.

In another aspect of the invention the spammers, who often count on anonymity, can also be identified. Since the spammer had to log into a pop3 server to send the reply to the authentication request, the ISP providing the pop3 server can be identified, and will have the identifying information necessary to identify and curtail the source of the spam. It should be noted that while the invention has been described by reference to the preferred embodiments described above, the invention is not limited to any particular operating system, programming language or unmentioned underlying protocols below or above the TCP/IP layer.

This invention is not limited to the current RFC documents specified herein. It should be noted that while it is based on RFC821/1869, it is assumed that continued expansions in the specifications would be expected and even that some mail systems may in the future use specifications that are not based on the specifications mentioned herein and that the processes described herein would still be applicable and thus within the scope of the invention.

What is claimed is:

1. A method of screening email comprising the steps of:
providing an email address for receiving incoming email;
providing a list of approved email sources that are authorized to send email messages to the email address;
receiving an incoming email addressed to the email address;
identifying the source of the incoming email message;
delivering the incoming email message to the email address if the source is an approved email source;
temporarily blocking delivery of the email to the receiving address and storing the incoming email message if the source of the incoming email is an approved email source;
sending an email to the source of the blocked email message requesting authentication of the source by entry of a reply command by the source;
if no reply is received to the source authorization request, rejecting the temporarily stored incoming email message;
if a reply is received responsive to the source authorization request, comparing the source of the reply to the source of the incoming email message; and,
if the source of the reply is the same as the source of the incoming email, delivering the incoming email to the email address.

2. A method according to claim 1 further comprising:
inserting a first predetermined series of characters in the authenticating email header of the authenticating email, and,
wherein the step of comparing the source of the reply to the source of the incoming email message including the step of determining if the reply email header includes the first predetermined series of characters.

3. A method according to claim 2 further comprising:
the authenticating email having a subject box;
inserting a second predetermined series of characters in the authenticating email subject box; and,
determining if the reply email includes a subject box containing the second predetermined series of characters.

4. A method according to claim 1 wherein the step of comparing the source of the reply to the source of the incoming email message further comprises:
comparing the email header field of the incoming email message to the email header of the reply;
delivering the incoming email to the email address for receiving incoming email if a predetermined number of the reply email header fields and the incoming message fields match; and,
rejecting the incoming email if less than a predetermined number of the reply email header fields and the incoming message fields match.

5. A method according to claim 4 wherein the email header fields are selected from the group consisting of the return-path field, the reply-to field, the X-sender field, the FROM field, the X-mailer field, the message-ID field, and the connecting IP address field.

6. A method according to claim 4 wherein the predetermined number of email header fields is at least 2.

7. A method according to claim 4 wherein the predetermined number of email header fields is at least 3.

8. A method according to claim 4 wherein the predetermined number of email header fields is at least 4.

9. A method according to claim 4 wherein the predetermined number of email header fields is at least 5.

10. A method according to claim 4 wherein the first predetermined series of characters in the authenticating email header of the authenticating email comprises “sourceauthentication:”
